(19) United States
(12) Patent Application Publication
(10) Pub. No.: US 2010/0004931 A1
(43) Pub. Date: Jan. 7, 2010

(54) Apparatus and method for speech utterance verification

(76) Inventors: Bin Ma, Singapore (SG); Haizhou Li, Singapore (SG); Minghui Dong, Singapore (SG)

Correspondence Address: KILYK & BOWERSOX, P.L.L.C., 3925 CHAIN BRIDGE ROAD, SUITE D401, FAIRFAX, VA, 22030, US

(21) Appl. No.: 12/311,008

(22) PCT Filed: Sep. 15, 2006
(86) PCT No.: PCT/SG2006/000272

§ 371 Date: Mar. 16, 2009

(51) Int. Cl. G10L 15/06; G10L 15/04

(52) U.S. Cl. 704/244; 704/251; 704/E15.005; 704/E15.002

(57) ABSTRACT

An apparatus is provided for speech utterance verification. The apparatus is configured to compare a first prosody component from a recorded speech with a second prosody component for a reference speech. The apparatus determines a prosodic verification evaluation for the recorded speech utterance in dependence of the comparison.

The present invention relates to an apparatus and method for speech utterance verification. In particular, the invention relates to a determination of a prosodic verification evaluation for a user's recorded speech utterance.

In computer aided language learning (CALL) systems, a significant problem is how to evaluate the correctness of a language learner's speech. This is a problem of utterance verification. In known CALL systems, a confidence score for the verification is calculated by evaluating the user's input speech utterance using acoustic models.

Speech recognition is a problem of pattern matching. Recorded speech patterns are treated as sequences of electrical signals. A recognition process involves classifying segments of the sequence into categories of pre-learned patterns. Units of the patterns may be words, sub-word units such as phonemes, or other speech segments. In many current automatic speech recognition (ASR) systems, the Hidden Markov Model (HMM) [1, 2, 3] is the prevalent tool for acoustic modelling and has been adopted in almost all successful speech research systems and commercial products. Generally speaking, known HMM-based speaker-independent ASR systems employ utterance verification by calculating a confidence score for correctness of an input speech signal representing the phonetic part of a user's speech using acoustic models. That is, known utterance verification methods focus on the user's pronunciation.

Utterance verification is an important tool in many applications of speech recognition systems, such as key-word spotting, language understanding, dialogue management, and language learning. In the past few decades, many methods have been proposed for utterance verification. Filler or garbage models [4, 5] have been used to calculate a likelihood score for both key-word and whole utterances. The hypothesis test approach was used by comparing the likelihood ratio with a threshold [6, 7]. The minimum verification error estimation [8] approach has been used to model both null and alternative hypotheses. High-level information, such as syntactical or semantic information, was also studied to provide some clues for the calculation of confidence measure [9, 10, 11]. The in-search data selection procedure [12] was applied to collect the most representative competing tokens for each HMM. The competing information based method [13] has also been proposed for utterance verification.

These known methods have their limitations because a great deal of useful speech information, which exists in the original speech signal, is lost in acoustic models.

The invention is defined in the independent claims. Some optional features of the invention are defined in the dependent claims.

To speak correctly in a particular language, language students should master prosody of the language; not only the pronunciation of the words should be uttered correctly. The speech should have the correct prosody (rhythm, pitch, tone, intonation, etc).

Prosody determines the naturalness of speech [21, 24]. The level of prosodic correctness can be a particularly useful measure for assessing the manner in which a student is progressing in his/her studies. For example, in some languages, prosody differentiates meanings of sounds [25, 26] and for a student to speak with correct prosody is key to learning the language. For example, in Mandarin Chinese, the tone applied to a syllable by the speaker imparts meaning to the syllable.

By determining a verification evaluation of prosodic data derived from a user's recorded speech utterance, a better evaluation of the user's progress in learning the target language may be made.

For each input speech utterance, use of a reference speech utterance makes it possible to evaluate the user's speech more accurately and more robustly. The user's speech utterance is processed and by manipulating an electrical signal representing a recording of the user's speech to extract a representation of the prosody of the speech, this is compared with the reference speech utterance. An advantageous result of this is that it is then possible to achieve a better utterance verification decision. Hitherto, it has not been contemplated to extract prosody information from a recorded speech signal for use in speech evaluation. One reason for this is that known systems for speech verification utilise HMMs (as discussed above) which can be used only for manipulation of the acoustic component of the user's speech. A hitherto unrecognised constraint of HMMs is that HMMs, by their very nature, do not utilise a great deal of information contained in a user's original speech, including prosody, and/or co-articulation and/or segmental information, which is not reserved in a normal HMM. However, the features (e.g. prosody) that are not included in the speech recognition models are very important from the point of view of human perception and for the correctness and naturalness of spoken language.

Speech prosody can be defined as variable properties of speech such as at least one of pitch, duration, loudness, tone, rhythm, intonation, etc. A summary of some main components of speech prosody can be given as follows:
Timing of speech units: at unit level, this means the duration of each unit. At utterance level, it represents the rhythm of the speech; e.g. how the speech units are organised in the speech utterance. Due to the existence of the rhythm, listeners can perceive words or phrases in speech with more ease.
Pitch of speech units: at unit level, this is the local pitch contour of the unit. For example, in Mandarin Chinese, the pitch contour of a syllable represents the tone of the syllable. At utterance level, the pitch contour of the utterance represents the intonation of the whole utterance. In other languages—especially Western languages—questioning utterances usually have a rising intonation, and hence a rising pitch contour.
Energy: energy represents loudness of speech. This is not as sensitive as timing and pitch to human ears.

Essentially, the principles of operation of the speech utterance evaluation of prosody can be implemented for any one or combination of a number of prosody parameters. For instance, a list of prosody parameters which can be defined for, for example, Mandarin Chinese are:
Duration of speech unit
Duration of the voiced part of the unit
Mean pitch value of voice part of the unit
Top line of pitch contour of the unit
Bottom line of pitch contour of the unit
Pitch value of start point of voiced part
Pitch value of end point of voiced part
Energy value of the complete unit measured in dB

To evaluate the prosody of a recorded speech, it is possible first to look at the prosody appropriateness of each unit itself. For different languages, there are different ways to define a speech unit. One such speech unit is a syllable, which is a typical unit that can be used for prosody evaluation.

In one apparatus for speech utterance verification, the prosodic verification evaluation is determined by using a reference speech template derived from live speech created from a Text-to-Speech (TTS) module. Alternatively, the reference speech template can be derived from recorded speech. The live speech is processed to provide a reference speech utterance against which the user is evaluated. Compared with using acoustic models, live speech contains more useful information, such as prosody, co-articulation and segmental information, which helps to make for a better evaluation of the user's speech. In another apparatus, prosody parameters are extracted from a user's recorded speech signal and compared to prosody parameters from the input text to the TTS module.

It has been found by the inventors that speech utterance unit timing and pitch contour are particularly useful parameters to derive from the user's input speech signal and use in a prosody evaluation of the user's speech.

The present invention will now be described, by way of example only, and with reference to the accompanying drawings in which:

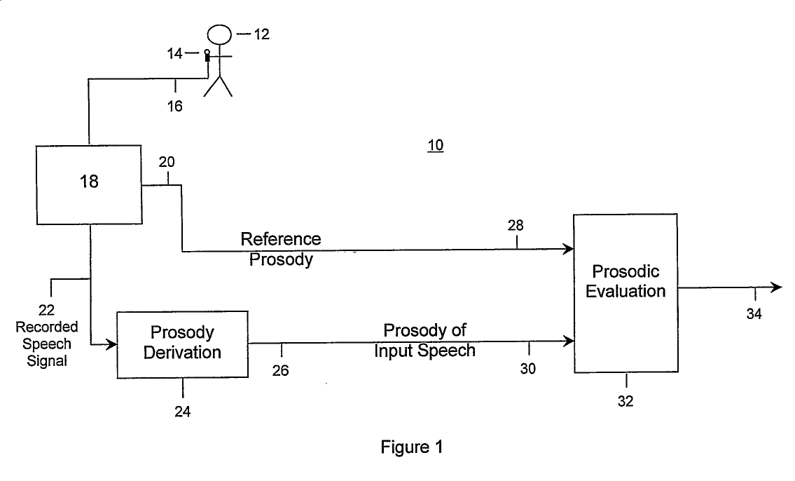

FIG. 1 is a block diagram illustrating a first apparatus for evaluation of a user's speech prosody;

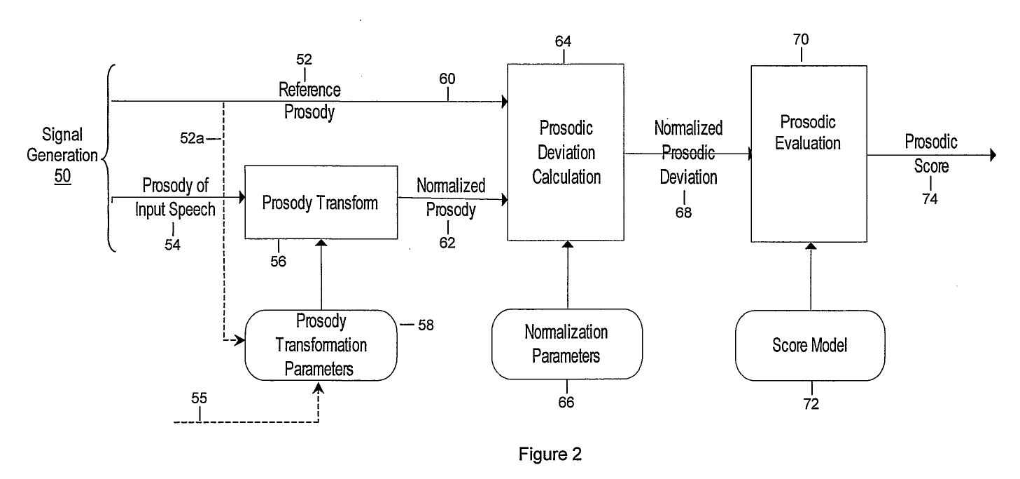

FIG. 2 is a block diagram illustrating a second apparatus for evaluation of a user's speech prosody;

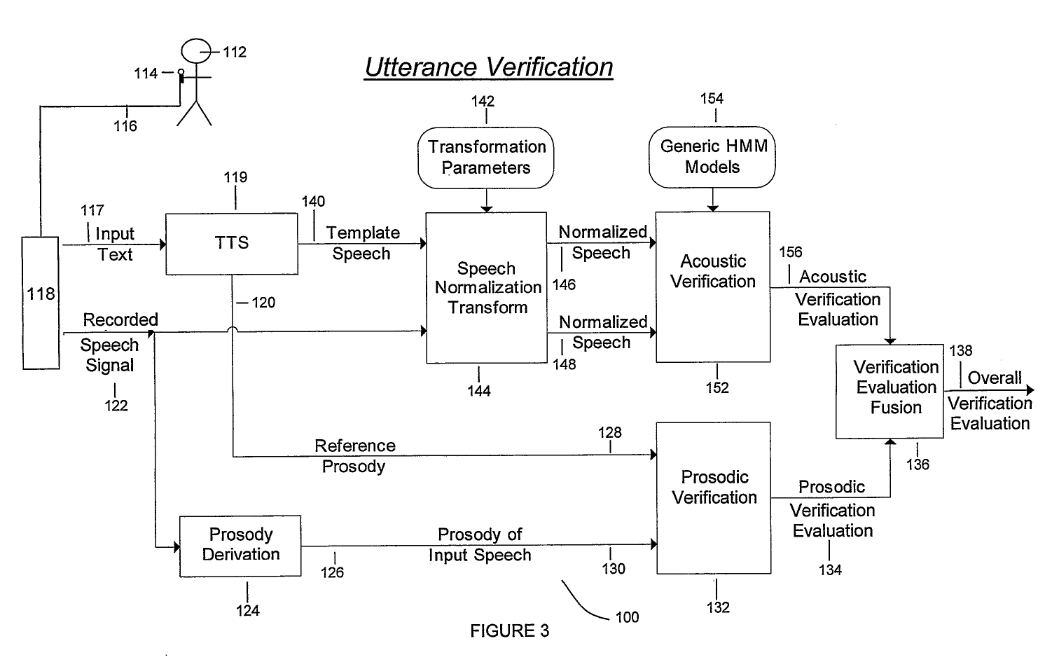

FIG. 3 is a block diagram illustrating an example in which the apparatus of FIG. 1 is implemented in conjunction with an acoustic model;

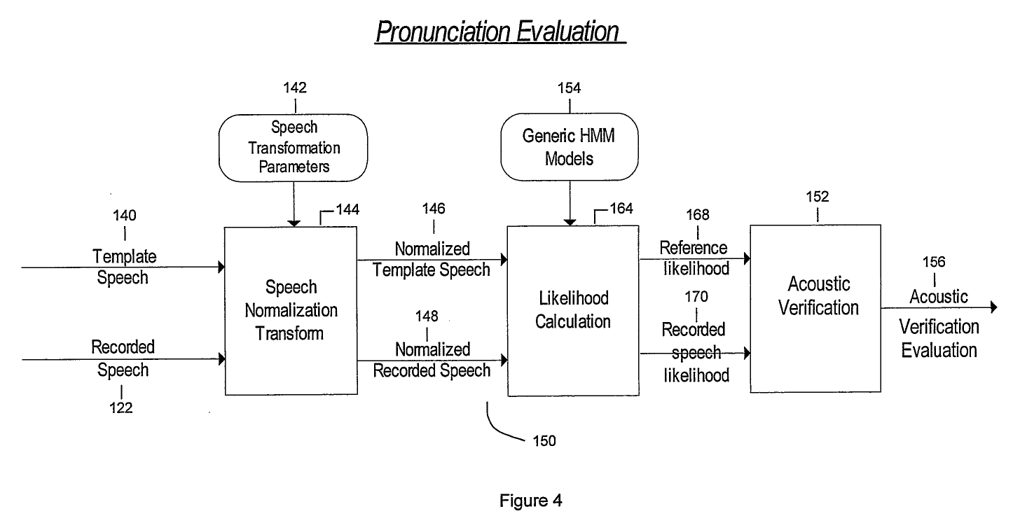

FIG. 4 is a block diagram illustrating an apparatus for evaluation of a user's speech pronunciation;

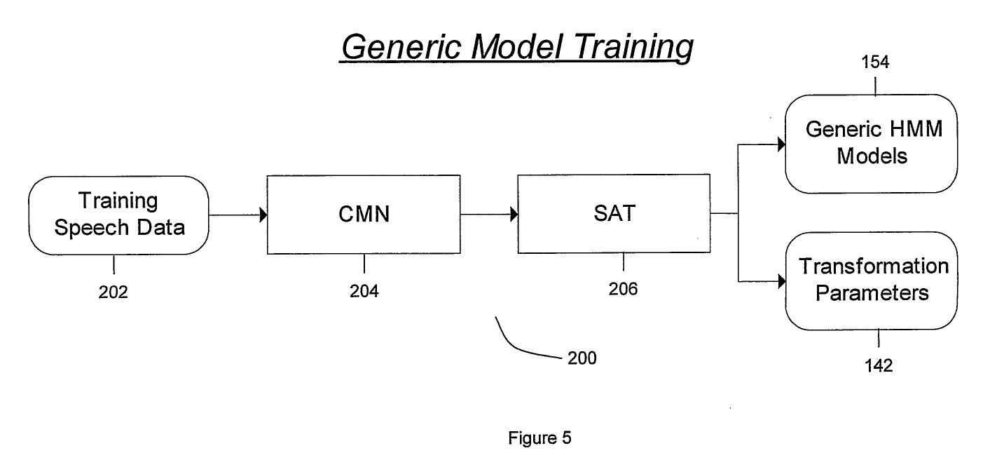

FIG. 5 is a block diagram illustrating generation of operators for use in the acoustic model of FIGS. 3 and 4;

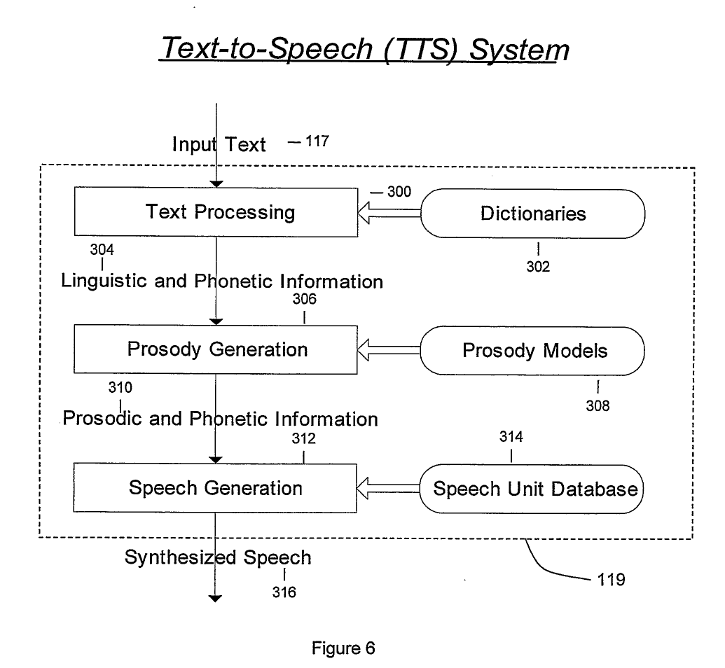

FIG. 6 is a block diagram illustrating the framework of a text-to-speech (TTS) apparatus;

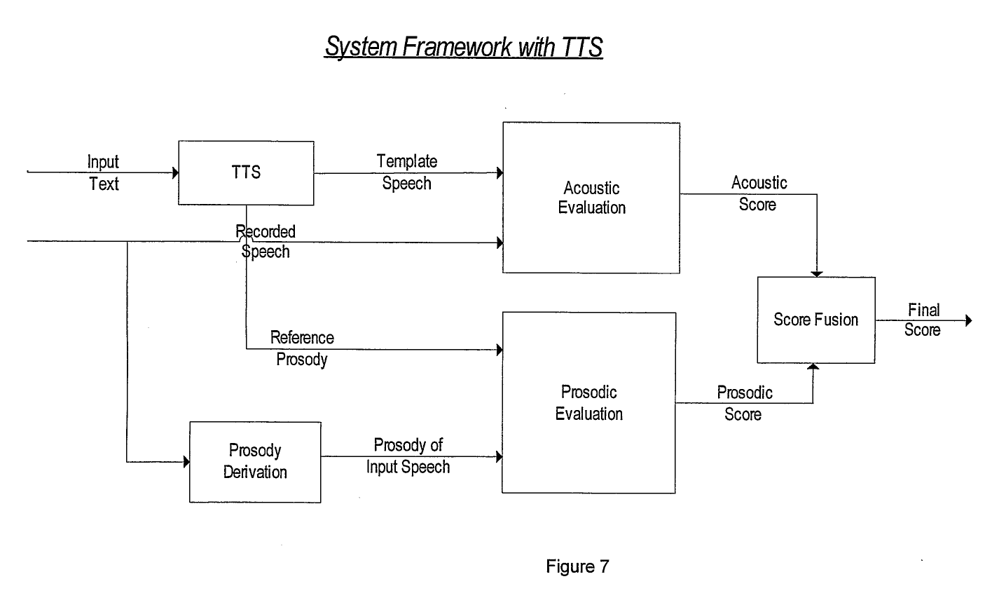

FIG. 7 is a block diagram illustrating the framework of an apparatus for evaluation of a user's speech utilising TTS; and

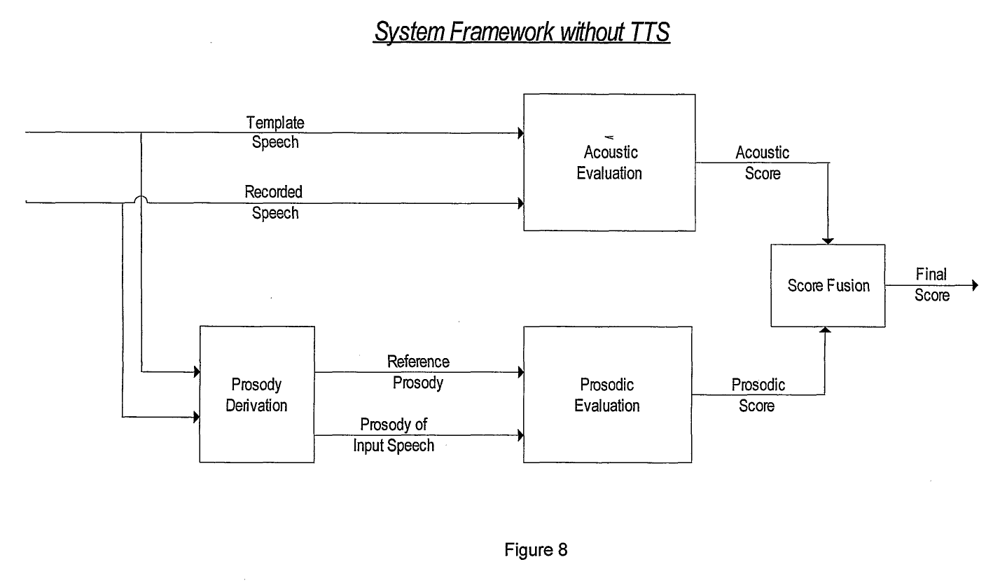

FIG. 8 is a block diagram illustrating the framework of an apparatus for evaluation of a user's speech without utilisation of TTS.

Referring to FIG. 1, a first example of an apparatus for prosodic speech utterance verification evaluation will now be described.

The apparatus 10 is configured to record a speech utterance from a user 12 having a microphone 14. In the illustrated apparatus, microphone 14 is connected to processor 18 by means of microphone cable 16. In one apparatus, processor 18 is a personal computer. Microphone 14 may be integral with processor 18. Processor 18 generates two outputs: a reference prosody signal 20 and a recorded speech signal 22. Recorded speech signal 22 is a representation, in electrical signal form, of the user's speech utterance recorded by microphone 14 and converted to an electrical signal by the microphone 14 and processed by processor 18. The speech utterance signal is processed and divided into units (a unit can be a syllable, a phoneme or an other arbitrary unit of speech). Reference prosody 20 may be generated in a number of ways and is used as a “reference” signal against which the user's recorded prosody is to be evaluated.

Prosody derivation block 24 processes and manipulates recorded speech signal 22 to extract the prosody of the speech utterance and outputs the recorded input speech prosody 26. The recorded speech prosody 26 is input 30 to prosodic evaluation block 32 for evaluation of the prosody of the speech of user 12 with respect to the reference prosody 20 which is input 28 to prosodic evaluation block 32. An evaluation verification 34 of the recorded prosody signal 26 is output from block 32. Thus, it can be seen that the prosodic evaluation block 32 compares a first prosody component derived from a recorded speech utterance with a corresponding second prosody component for a reference speech utterance and determines a prosodic verification evaluation for the recorded speech utterance unit in dependence of the comparison. In the apparatus of FIG. 1, the prosody components comprise prosody parameters, as described below.

The prosody evaluation can be effected by a number of methods, either alone, in combination with one another. Prosodic evaluation block 32 makes a comparison between a first prosody parameter of the recorded speech utterance (e.g. either a unit of the user's recorded speech or the entire utterance) and a corresponding second prosody parameter for a reference speech utterance (e.g. the reference prosody unit or utterance). By “corresponding” it is meant that at least the prosody parameters for the recorded and reference speech utterances correspond with one another; e.g. they both relate to the same prosodic parameter, such as duration of a unit.

The apparatus is configured to determine the prosodic verification evaluation from a comparison of first and second prosody parameters which are corresponding parameters for at least one of: (i) speech utterance unit duration; (ii) speech utterance unit pitch contour; (iii) speech utterance rhythm; and (iv) speech utterance intonation; of the recorded and reference speech utterances respectively.

A first example of a comparison at unit level is now discussed.

### (i) Duration of Unit

In any language learning process, a student is expected to follow the speech of the reference (teacher). Ideally, the student's speech rate should be the same as the reference speech rate. One method of performing a verification evaluation of the student's speech, is for prosody evaluation block 32 to determine the prosodic verification evaluation from a comparison of first and second prosody parameters for speech utterance unit duration from a transform of a normalised duration deviation of the recorded speech utterance unit duration to provide a transformed normalised duration deviation.

That is, the evaluation is determined as follows. First, prosody derivation block 24 determines the normalised duration deviation of the recorded speech unit from:

aⱼⁿ=(aⱼ^{t}−aⱼ^{r})/aⱼ^{s} (1)

where aⱼⁿ, aⱼ^{t}, aⱼ^{r} and aⱼ^{s} are the normalised unit duration deviation, the actual duration of the student's recorded speech unit—e.g. output 26 from block 24, the predicted duration of the reference unit—e.g. output 20 from processor 18—and the standard deviation of the duration of unit j respectively. The standard deviation of the duration of unit j is a pre-calculated statistical result of some training samples of the class to which unit j belongs. Thus it can be considered that prosody derivation block 24 calculates the “distance” between the user's speech prosody and the reference speech prosody.

The normalised unit duration deviation signal is manipulated and converted to a verification evaluation (confidence score) using the following function:

qⱼ^{a}=λ^{a}(aⱼⁿ) (2)

where qⱼ^{a} is the verification evaluation of the duration of the recorded unit j of the student's speech, and λ^{a}( ) is a transform function for the normalised duration deviation. This transform function converts the normalised duration deviation into a score on a scale that is more understandable (for example, on a 0 to 100 scale). This can be implemented using a mapping table, for example. The mapping table is built with human scored data pairs which represent mapping from a normalised unit duration deviation signal to a verification evaluation score.

A second example of a comparison at unit level is now discussed.

### (ii) Pitch Contour of Unit

Transforming the Prosody Parameters: The pitch contour of the unit is represented by a set of parameters. (For example, this can be n pitch sample values, p₁, p₂, . . . pₙ, which are evenly sampled from the pitch contour of the speech unit.) In this example, the reference prosody model 20 is built using a speech corpus of a professional speaker (defined as a standard voice or a teacher's voice). The generated prosody parameters of the reference prosody 20 are ideal prosody parameters of the professional speaker's voice. Before evaluating the pitch contour of a unit of the user's speech signal, the prosody of the user's speech unit is mapped to the teacher's prosody space by prosodic evaluation block 32. Manipulation of the signal is effected with the following transform:

pᵢ^{t}=aᵢ+bᵢpᵢ^{s} (3)

where pᵢ^{s} is the i-th parameter value from the student's speech, pᵢ^{t} is the i-th predicted parameter value from the reference prosody 20, aᵢ and bᵢ are regression parameters for the i-th prosody parameter. The regression parameters are determined using the first few utterances from a sample of the user's speech.

Calculating Pitch Contour Evaluation: The prosody verification evaluation is determined by comparing the predicted parameters from the reference speech utterance unit with the transformed actual parameters of the recorded speech utterance unit. The normalised parameter for the i-th parameter is defined by:

tᵢ=(pᵢ−rᵢ)/sᵢ (4)

where pᵢ, rᵢ and sᵢ are predicted pitch parameter of the template, actual pitch parameters of speech and standard deviation of the predicted class of the i-th parameter. Then prosody evaluation block 32 determines the verification evaluation for the pitch contour from the following transform of the normalised pitch parameter:

q^{b}=λ^{b}(T) (5)

where T=(t₁, t₂, . . . tₙ) is the normalised parameter vector, n is the number of prosody parameters and λ^{b} is a transform function which converts the normalised duration deviation into a score on a scale that is more understandable (for example, on a 0 to 100 scale), similar in operational principle to λ^{a}. λ^{a} is implemented with a regression tree approach [29]. The regression tree is trained with human scored data pairs, which represent mapping from a normalised pitch vector to a verification evaluation score. Thus it can be seen that the prosodic evaluation block 32 determines the prosodic verification evaluation from a comparison of first and second groups of prosody parameters for speech utterance unit pitch contour from: a transform of a prosody parameter of the recorded speech utterance unit to provide a transformed parameter; a comparison of the transformed parameter with a corresponding predicted parameter derived from the reference speech utterance unit to provide a normalised transformed parameter; a vectorisation of a plurality of normalised transformed parameters to form a normalised parameter vector; and a transform of the normalised parameter vector to provide a transformed normalised parameter vector.

A first example of a comparison at utterance level is now described.

(iii) Speech Rhythm

To compare the rhythm of the recorded speech utterance unit with the reference speech utterance, a comparison is made of the time interval between two units of each of the recorded and reference speech utterances by prosodic evaluation block 32. In one example, the comparison is made between successive units of speech. In another example, the comparison is made between every pair of successive units in the utterance and their counterpart in the reference template where there are more than two units in the utterance.

The comparison is made by evaluating the recorded and reference speech utterance signals and determining the time interval between the centres of the two units in question.

Prosody derivation block 24 determines the normalised time interval deviation from:

cⱼⁿ=(cⱼ^{t}−cⱼ^{r})/cⱼ^{s} (6)

where cⱼⁿ, cⱼ^{t}, cⱼ^{r} and cⱼ^{s} are normalised time interval deviation, time interval between two units in the recorded speech utterance, time interval between two units in the reference speech utterance, and the standard deviation of the j-th time interval between units respectively.

For the whole utterance, prosodic evaluation block 32 determines the prosodic verification evaluation for rhythm from:

$$\begin{matrix}c = {( {\sum }_{j = 1}^{m - 1} {( {c}_{j}^{n} )}^{2} / ( m - 1 ) )}^{\frac{1}{2}} & ( 7 ) \\ {q}^{c} = {λ}^{c} ( c ) & ( 8 )\end{matrix}$$

where q^{c} is the confidence score for rhythm of the utterance, m is the number of units in the utterance (there are m−1 intervals between m units), and λ^{c}( ) is a transform function to convert the normalised time interval variation to a verification evaluation for speech rhythm similar to λ^{a} and λ^{b}.

It should be noted that the rhythm scoring method can be applied to both whole utterances and part of a utterance. Thus, the method is able to detect abnormal rhythm of any part of an utterance.

Thus, the prosodic evaluation block 32 determines the prosodic verification evaluation from a comparison of first and second prosody parameters for speech utterance rhythm from: a determination of recorded time intervals between pairs of recorded speech utterance units; a determination of reference time intervals between pairs of reference speech utterance units; a normalisation of the recorded time intervals with respect to the reference time intervals to provide a normalised time interval deviation for each pair of recorded speech utterance units; and a transform of a sum of a plurality of normalised time interval deviations to provide a transformed normalised time interval deviation.

A second example of a comparison at utterance level is now discussed.

### (iv) Intonation of Utterance

To compare the intonation of the recorded and reference speech utterances, the average pitch value of each unit of the respective signals are compared. The pitch contour of an utterance is transformed by a sequence of pitch values of the units of the signal representing the utterances by prosody derivation block 24. Two sequences of pitch values are compared by prosodic evaluation block 32 to determine a verification evaluation.

Because speech utterances of different speakers have different average pitch levels, before comparison, the pitch difference between speakers is removed from the signal by prosody derivation block 24. Therefore, the two sequences of pitch values are normalised to zero mean.

Then the normalised pitch deviation is determined from:

$$\begin{matrix}{d}_{j}^{n} = ( ( {d}_{j}^{t} - {\overline{d}}^{t} ) - ( {d}_{j}^{r} - {\overline{d}}^{r} ) ) / {d}_{j}^{s} & ( 9 ) \\ d = {( {\sum }_{j = 1}^{m} {( {d}_{j}^{n} )}^{2} / m )}^{\frac{1}{2}} & ( 10 )\end{matrix}$$

where dⱼⁿ, dⱼ^{t}, dⱼ^{r}, dⱼ^{s} are normalised pitch deviation, pitch mean of the recorded utterance, pitch mean of the reference speech utterance, and standard deviation of pitch variation for unit i respectively, d̅^{t}, d̅^{s} are mean values of pitch values of recorded utterance and reference utterance respectively.

For the whole utterance, the verification evaluation for intonation is determined from:

q^{d}=λ^{d}(d) (11)

where q^{d} is the verification evaluation of the utterance intonation, and λ^{d}( ) is a another transform function to convert the average deviation of utterance pitch to the verification evaluation for intonation of utterance similar to λ^{a} etc.

This intonation scoring method can be applied to whole utterance or part of an utterance. Therefore, it is possible to detect any abnormal intonation in an utterance.

Thus, the prosodic evaluation block 32 determines the prosodic verification evaluation from a comparison of first and second prosody parameters for speech utterance intonation from: a determination of the recorded pitch mean of a plurality of recorded speech utterance units; a determination of the reference pitch mean of a plurality of reference speech utterance units; a normalisation of the recorded pitch mean and the reference pitch mean to provide a normalised pitch deviation; and a transform of a sum of a plurality of normalised pitch deviations to provide a transformed normalised pitch deviation.

In one apparatus, a composite prosodic verification evaluation can be determined from one or more of the above verification evaluations. In one apparatus, weighted scores of two or more individual verification evaluations are summed.

That is, the composite prosodic verification evaluation can be determined by a weighted sum of the individual prosody verification evaluations determined from above:

$${q}^{p} = {w}_{a} {\sum }_{j = 1}^{n} {q}_{j}^{a} + {w}_{b} {\sum }_{j = 1}^{n} {q}_{j}^{b} + {w}_{c} {q}^{c} + {w}_{d} {q}^{d} \qquad ( 12 )$$

where wₐ, w_{b}, w_{c}, w_{d} are weights for each verification evaluation (i) to (iv) respectively.

Further, FIG. 1 illustrates an apparatus for speech utterance verification, the apparatus being configured to determine a prosody component of a user's recorded speech utterance and compare the component with a corresponding prosody component of a reference speech utterance. The apparatus determines a prosody verification evaluation in dependence of the comparison. In FIG. 1, the component of the user's recorded speech is a prosody property such as speech unit duration or pitch contour, etc.

Referring to FIG. 2, a second example of an apparatus for prosodic speech utterance verification evaluation will now be described.

In summary, the apparatus of FIG. 2 operates as follows. The functionality is discussed in greater detail below.

Reference prosody 52 and input speech prosody 54 signals are generated 50 in accordance with the principles of FIG. 1. Reference prosody signal 52 is input 60 to prosodic deviation calculation block 64. Input speech prosody signal 54 is converted to a normalised prosody signal 62 by prosody transform block 56 with support from prosody transformation parameters 58. Prosody transform block 56 maps the input speech prosody signal 54 to the space of the reference prosody signal 52 by removing intrinsic differences (e.g. pitch level) between the user's recorded speech prosody and the teacher's speech prosody. The prosody transformation parameters are derived from a few samples of the user's speech which provide a “calibration” function for that user prior to the user's first use of the apparatus for study/learning purposes.

Normalised prosody signal 62 is input to prosodic deviation calculation block 64 for calculation of the deviation of the user's input speech prosody parameters when compared with the reference prosody signal 52. Prosodic deviation calculation block 64 calculates a degree of difference between the user's prosody and the reference prosody with support from a set of normalisation parameters 66, which are standard deviation values. The standard deviation values are pre-calculated from training speech or predicted by the prosody model, e.g. prosody model 308 of FIG. 6. The standard deviation values are pre-calculated from a group of sample prosody parameters calculated from a training speech corpus. Two ways to calculate the standard deviation values are: (1) All units in the language can be considered as one group; (2) or the units can be classified into some categories. For each category, one set of values are calculated.

The output signal 68 of prosodic deviation block 64 is a normalised prosodic deviation signal, represented by a vector or group of vectors.

The normalised prosodic deviation vector(s) are input to prosodic evaluation block 70 which converts the normalised prosodic deviation vector(s) into a likely score value. This process converts the vector(s) in normalised prosodic deviation signal 68 into a single value as a measurement or indication of correctness of the user's prosody. The process is supported by score models 72 trained from training corpus.

The apparatus of FIG. 2 and the signals manipulated by the apparatus are now discussed in detail.

In addition to unit level and utterance level prosody parameters as defined above in relation to the apparatus of FIG. 1, it is possible to make an evaluation of the rhythm of an utterance by determining a relationship between successive speech units in an utterance. Such “across-unit” parameters are determined by comparing parameters of two successive units. The apparatus of FIG. 2 is configured to define the length of interval between two units and the change of pitch values between two units. For example, for Mandarin Chinese, the following across-unit prosody parameters are defined:
An interval between a start point of one unit and an end point of the other unit
An interval between a mid-point of one unit and a mid-point of the other unit
A difference between a mean pitch value of one unit and a mean pitch value for the other unit
A difference between a pitch value of a start point of one unit B and a pitch value of a start point for the other unit

Before evaluating the user's speech, the user's input speech prosody signal 54 is mapped to the prosody space of the reference prosody signal 52 to ensure that user's prosody signal is comparable with the reference prosody. A transform is executed by prosody transform block 56 with the prosody transformation parameters 58 according to the following signal manipulation:

pᵢ^{t}=aᵢ+bᵢpᵢ^{s} (13)

where pᵢ^{s} is a prosody parameter from the user's speech, pᵢ^{t} is a prosody parameter from the reference speech signal (denoted by 52a), aᵢ and bᵢ are regression parameters for the i-th prosody parameter.

There are a number of different ways to calculate the regression parameters. For example, it is possible to use a sample of the user's speech to estimate the regression parameters. In this way, before actual prosody evaluation, a few samples 55 of speech utterances of the user speech are recorded to estimate the regression parameters and supplied to prosody transformation parameter set 58.

For each unit, the apparatus of FIG. 2 generates a unit level prosody parameter vector, and an across-unit prosody parameter vector for each pair of successive units. The unit level prosody parameters account for prosody events like accent, tone, etc., while the across unit parameters are used to account for prosodic boundary information (which can also be referred to as prosodic break information and means the interval between first and second speech units which, respectively, mark the end of one phrase or utterance and the start of another phrase or utterance). The apparatus of FIG. 2 is configured to represent both the reference prosody signal 52 and the user's input speech prosody signal 54 with a unit level prosody parameter vector, and an across-unit prosody parameter vector. Across-unit prosody and unit prosody can be considered to be two parts of prosody. In the apparatus of FIG. 2, the across-unit prosody vector and unit prosody vector of the recorded speech utterance are derived by prosody transform block 56. The reference prosody vector of signal 52 is generated in signal generation 50. The apparatus of FIG. 2 is configured to generate and manipulate the following prosody vectors:
p^{a}ⱼ denotes a unit level prosody parameter vector of unit j of user's speech.
p^{b}ⱼ denotes an across-unit prosody parameter vector between units j and j+1 of the user's speech.
R^{a}ⱼ denotes a unit level prosody parameter vector of unit j of the reference speech.
R^{b}ⱼ denotes an across-unit prosody parameter vector between units j and j+1 of the reference speech.

Transformation (13) in prosody transform block 56 may be represented by the following:

Q^{a}ⱼ=T^{a}(P^{a}ⱼ) (14)

Q^{b}ⱼ=T^{b}(P^{b}ⱼ) (15)

Where T^{a}( ) denotes the transformation for unit level prosody parameter vector, T^{b}( ) denotes the transformation for across-unit prosody parameter vector, Q^{a}ⱼ denotes the transformed unit level prosody parameter vector of unit j of user speech, and Q^{b}ⱼ denotes the transformed across unit prosody parameter vector between unit j and unit j+1 of user speech.

Similarly to the apparatus of FIG. 1, a user's speech prosody parameters in the apparatus of FIG. 2 will be similar to the reference speech prosody parameters. Prosodic deviation calculation block 64 calculates a normalised prosodic deviation parameter of the user's prosody from the following:

aᵢⁿ=(aᵢ^{t}−aᵢ^{r})/aᵢ^{s} (16)

where aᵢⁿ, aᵢ^{t}, aᵢ^{r} and aᵢ^{s} are normalised prosody parameter deviation, the transformed parameter of the user speech prosody, the reference prosody parameter, and the standard deviation of parameter i from normalisation parameter block 66. Both the unit prosody and across-unit prosody parameters are processed this way.

Therefore, for each of the unit prosody and across-unit prosody parameters, a representation of equation 16 can be expressed as:

D^{a}ⱼ=N^{a}(Q^{a}ⱼ,R^{a}ⱼ) (17)

D^{b}ⱼ=N^{b}(Q^{b}ⱼ,R^{b}ⱼ) (18)

Where D^{a}ⱼ denotes the normalised deviation vector of unit j, D^{b}ⱼ denotes the normalised deviation vector of across-unit level prosody parameter vector between units j and j+1, N^{a}( ) denotes the normalisation function for the unit level prosody parameter vector, and N^{b}( ) denotes the normalization function for the across unit prosody parameter vector. Thus, prosodic deviation calculation block 64 generates a normalised deviation unit prosody vector defined by equation (17) and an across-unit prosody vector defined by equation (18) from normalised prosody signal 62 (normalised unit and across-unit prosody vectors) and reference prosody signal 52 (unit and across-unit prosody parameter vectors). These signals are output as normalised prosodic deviation vector signal 68 from block 64.

When normalised deviations for a unit are derived, a confidence score based on the deviation vector is then calculated. This process converts the normalised deviation vector into a likelihood value; that is, a likelihood of how correct the user's prosody is with respect to the reference speech.

Prosodic evaluation block 70 determines a prosodic verification evaluation for the user's recorded speech utterance from signal manipulations represented by the following:

q^{a}ⱼ=p^{a}(D^{a}ⱼ|λ^{a}) (19)

q^{b}ⱼ=p^{b}(D^{b}ⱼ|λ^{b}) (20)

where q^{a}ⱼ is a log prosodic verification evaluation of the unit prosody for unit j, p^{a}( ) is the probability function for unit prosody, λ^{a} is a Gaussian Mixture Model (GMM) [28] from score model block 72 for the prosodic likelihood calculation of unit prosody, q^{b}ⱼ is a log prosodic verification evaluation of the across-unit prosody between units j and j+1, p^{b}( ) is a probability function for across unit prosody, and λ^{b} is a GMM model for across-unit prosody from score model block 72. The GMM is pre-built with a collection of the normalised derivation vectors 68 calculated from a training speech corpus. The built GMM predicts the likelihood a given normalised derivation vector corresponds with a particular speech utterance.

A composite prosodic verification evaluation of unit sequence q^{p} for the apparatus of FIG. 2 can be determined by a weighted sum of individual prosodic verification evaluations defined by equations (19) and (20):

$${q}^{p} = {w}_{a} {\sum }_{j = 1}^{n} {q}_{j}^{a} + {w}_{b} {\sum }_{j = 1}^{n - 1} {q}_{j}^{b} \qquad ( 21 )$$

where wₐ, w_{b} are weights for each item respectively (default values for the weights are specified as 1 (unity) but this is configurable by the end user), and n is the number of units in the sequence.

Note that this formula can be use to calculate the score of both whole utterance and part of utterance depending on the target speech to be evaluated.

Differences between the apparatus of FIG. 1 and that of FIG. 2 include (1) the prosody components of the apparatus of FIG. 2 are prosody vectors; (2) the transformation of prosody parameters is applied to all the prosody parameters; (3) across-unit prosody contributes to the verification evaluation; and (4) the verification evaluations are likelihood values calculated with GMMs.

Advantageously, one apparatus generates an acoustic model, determines an acoustic verification evaluation from the acoustic model and determines an overall verification evaluation from the acoustic verification evaluation and the prosodic verification evaluation. That is, the prosody verification evaluation is combined (or fused) with an acoustic verification evaluation derived from an acoustic model, thereby to determine an overall verification evaluation which takes due consideration of phonetic information contained in the user's speech as well as the user's speech prosody. The acoustic model for determination of the correctness of the user's pronunciation is generated from the reference speech signal 140 generated by the TTS module 119 and/or the Speaker Adaptive Training Module (SAT) 206 of FIG. 5. The acoustic model is trained using speech data generated by the TTS module 119. A large amount of speech data from a large number of speakers should be requested. SAT is applied to create the generic HMM by removing speaker-specific information. An example of such an utterance verification system 100 is shown in FIG. 3. The system 100 comprises a sub-system for prosody verification with components 118, 124, 132 which correspond with those illustrated in and described with reference to FIG. 1.

In summary, the system 100 comprises the following main components:
Text-to-speech (TTS) Block 119: Given an input text 117 from processor 118, the TTS module 119 generates a phonetic reference speech 140, and the reference prosody 120 of the speech and labels (markers) of each acoustic speech unit. The function of the speech labels is discussed below.
Speech Normalisation Transform Block 144: In block 144, phonetic data from the recorded speech signal 122 and reference speech signal 140 are transformed to signals in which channel and speaker information is removed. That is channel (microphone 14, 114 and cable 16, 116) and user 12, 112 specific data are filtered from the signals. A normalised reference (template) phonetic speech signal 146 and a normalised recorded phonetic speech signal 148 are output from speech normalisation transform block 144. The purpose of this normalisation is to ensure the phonetic data of the two speech utterances are comparable. In the normalisation process, speech normalisation transform block 144 applies transformation parameters 142 derived as described with relation to FIG. 5.
Acoustic Verification Block 152: Acoustic verification block 152 receives as inputs normalised reference speech signal 146 and normalised recorded phonetic speech signal 148 from block 144. These signals are manipulated by a force alignment process in acoustic verification block 152 which generates an alignment result by aligning labels of each phonetic data of the recorded speech unit with the corresponding labels of phonetic data of the reference speech unit. (The labels being generated by TTS block 119 as mentioned above.) From the phonetic information of the reference speech, the recorded speech and corresponding labels, the acoustic verification block 152 determines an acoustic verification evaluation for each recorded speech unit. Acoustic verification block 152 applies generic HMM models 154 derived as described with relation to FIG. 5.
Prosody Derivation Block 124: Block 124 generates the prosody parameters of the recorded speech utterance, as described above with reference to FIG. 1.
Prosodic Verification Block 132: Block 132 determines a prosody verification evaluation for the recorded speech utterance as described above with reference to FIG. 1.
Verification Evaluation Fusion Block 136: Block 136 determines an overall verification evaluation for the recorded speech utterance by fusing the acoustic verification evaluation 156 determined by block 152 with the prosodic verification evaluation 134 determined by block 132.

Therefore, in the apparatus of FIG. 3, a recorded speech utterance is evaluated from a consideration of two aspects of the utterance: acoustic correctness and prosodic correctness by determination of both an acoustic verification evaluation and a prosodic verification evaluation. These can be considered as respective “confidence scores” in the correctness of the user's recorded speech utterance.

In the apparatus of FIG. 3, a text-to-speech module 119 is used to generate on-fly live speech as a reference speech. From the two aligned speech utterances, the verification evaluations describing segmental (acoustic) and supra-segmental (prosodic) information can be determined. The apparatus makes the comparison by alignment of the recorded speech utterance unit with the reference speech utterance unit.

The use of text-to-speech techniques has the following advantages in utterance verification. Firstly, the use of TTS system to generate speech utterances makes it possible to generate reference speech for any sample text and to verify speech utterance of any text in a more effective manner. This is because in known approaches texts to be verified are first designed and then the speech utterances must be read and recorded by a speaker. In such a process, only a limited number of utterances can be recorded. Further, only speech with the same text content as that which has been recorded can be verified by the system. This limits the use of known utterance verification technology significantly.

Secondly, compared to solely acoustic-model-based speech recognition systems, one apparatus and method provides an actual speech utterance as a reference for verification of the user's speech. Such concrete speech utterances provide more information than acoustic models. The models used for speech recognition only contain speech features that are suitable for distinguishing different speech sounds. By overlooking certain features considered unnecessary for phonetic evaluation (e.g. prosody), known speech recognition systems cannot discern so clearly variations of the user's speech with a reference speech.

Thirdly, the prosody model that is used in the Text-to-speech conversion process also facilitates evaluation of the prosody of the user's recorded speech utterance. The prosody model of TTS block 119 is trained with a large number of real speech samples, and then provides a robust prosody evaluation of the language.

To evaluate the correctness of the input speech utterance, acoustic verification block 152 compares each individual recorded speech unit with the corresponding speech unit of the reference speech utterance. The labels of start and end points of each unit for both recorded and reference speech utterances are generated by the TTS block 119 for this alignment process.

Acoustic verification block 152 obtains the labels of recorded speech units by aligning the recorded speech unit with its corresponding pronunciation. Taking advantage of recent advances in continuous speech recognition [27], the alignment is effected by application of a Viterbi algorithm in a dynamic programming search engine.

Determination of the acoustic verification evaluation 156 of system 100 is now discussed.

To determine the acoustic verification evaluation, both recorded and reference utterance speech units are evaluated with acoustic models. Acoustic verification block 152 determines the acoustic verification evaluation of the recorded speech utterance units from the following manipulation of the recorded and reference speech acoustic signal components:

qⱼ^{s}=ln p(Xⱼ|λⱼ)−ln p(Yⱼ|λⱼ) (22)

where qⱼ^{s} is the acoustic verification evaluation of one speech utterance unit, Xⱼ, Yⱼ are normalised recorded speech 148 and reference speech 146 respectively, and λⱼ is the acoustic model for expected pronunciation. p parameters are, respectively, likelihood values that the recorded and reference speech utterances match particular utterances.

The acoustic verification evaluation for the utterance is determined from the following signal manipulation:

$${q}^{s} = {\sum }_{j = 1}^{n} {q}_{j}^{s} / m \qquad ( 23 )$$

where q^{s} is the acoustic verification evaluation of the recorded speech utterance, and m is the number of units in the utterance.

Thus, verification evaluation fusion block 138 determines the acoustic verification evaluation from: a normalisation of a first acoustic parameter derived from the recorded speech utterance unit; a normalisation of a corresponding second acoustic parameter for the reference speech utterance unit; and a comparison of the first acoustic parameter and the second acoustic parameter with a phonetic model, the phonetic model being derived from the acoustic model.

Depending on the level at which the verification is evaluated, (e.g. unit level or utterance level), verification evaluation fusion block 136 determines the overall verification evaluation 138 as a weighted sum of the acoustic verification evaluation 156 and prosodic verification evaluation 134 as follows:

q=w₁q^{s}+w₂q^{p} (24)

where q, q^{s}, q^{p} are overall verification evaluation 138, acoustic verification evaluation 156 and prosody verification evaluation 134 respectively, and w₁ and w₂ are weights.

The final result can be presented at both sentence level and unit level. The overall verification evaluation is an index of the general correctness of the whole utterance of the language learner's speech. Meanwhile the individual verification evaluation of each unit can also be made to indicate the degree of correctness of the units.

Referring to FIG. 4, an example of a stand-alone apparatus for speech pronunciation evaluation will now be described. Where appropriate, like parts are denoted by like reference numerals.

The apparatus 150 comprises a speech normalisation transform block 144 operable in conjunction with a set of speech transformation parameters 142, a likelihood calculation block 164 operable in conjunction with a set of generic HMM models 154 and an acoustic verification module 152.

Reference (template) speech signals 140 and a user recorded speech utterance signals 122 are generated as before. These signals are fed into speech normalisation transform block 144 which operates as described with reference to FIG. 3 in conjunction with transformation parameters 142, described below with reference to FIG. 5. Normalised reference speech 146 and normalise recorded speech 148 are output from block 144 as described with reference to FIG. 3. For each of the normalised reference speech signal 146 and the normalised recorded speech signal 148, likelihood calculation block determines the probability that the signal 146, 148 is a particular utterance with reference to the HMM models 154, which are pre-calculated during a training process. These signals are output from block 164 as reference likelihood signal 168 and recorded speech likelihood 170 to acoustic verification block 152.

The acoustic verification block 152 calculates a final acoustic verification evaluation 156 based on a comparison of the two input likelihood values 168, 170.

Thus, FIG. 4, illustrates an apparatus for speech pronunciation verification, the apparatus being configured to determine an acoustic verification evaluation from: a determination of a first likelihood value that a first acoustic parameter derived from a recorded speech utterance unit corresponds to a particular utterance; a determination of a second likelihood value that a second acoustic parameter derived from a reference speech utterance corresponds to a particular utterance; and a comparison of the first likelihood value and the second likelihood value. The determination of the first likelihood value and the second likelihood value may be made with reference to a phonetic model; e.g. a Generic HMM model.

FIG. 5 shows the training process 200 of generic HMM models 154 and the transformation parameters 142 of FIG. 3. Cepstral mean normalisation (CMN) is first applied to training speech data 202 at block 204. Speaker Adaptive Training (SAT) is applied to the output of block 204 at block 206 to obtain the generic HMM models 154 and transformation parameters 142. SAT is applied to create the generic HMM by removing speaker-specific information from the training speech data 202. The generic HMM models 154, which are used for recognising normalised speech, are used in acoustic verification block 152 of FIG. 3. The transformation parameters 142 are used in the Speech Normalisation Transform block 144 of FIG. 3 to remove speaker-unique data in the phonetic speech signal. The generation of the transformation parameters 142 is explained with reference to FIG. 5.

To achieve a robust acoustic model, channel normalisation is handled first. The normalisation process can be carried out both in feature space and model space. Spectral subtraction [14] is used to compensate for additive noise. Cepstral mean normalisation (CMN) [15] is used to reduce some channel and speaker effects. Codeword dependent cepstral normalisation (CDCN) [16] is used to estimate the environmental parameters representing the additive noise and spectral tilt. ML-based feature normalisation, such as signal bias removal (SBR) [17] and stochastic matching [18] was developed for compensation. In the proposed template speech based utterance verification method, the speaker variations are also irrelevant information and are removed from the acoustic modelling. Vocal tract length normalisation (VTLN) [19] uses frequency warping to perform the speaker normalisation. Furthermore, linear regression transformations are used to normalise the irrelevant variability. Speaker adaptive training 206 (SAT) [20] is used to apply transformations on mean vectors of HMMs based on the maximum likelihood scheme, and is expected to achieve a set of compact speech models. In one apparatus, both CMN and SAT are used to generate generic acoustic models.

As mentioned above, cepstral mean normalisation is used to reduce some channel and speaker effects. The concept of CMN is simple and straightforward. Given a speech utterance X={xₜ,1≦t≦T}, the normalisation is made for each unit by removing the mean vector μ of the whole utterance:

x̅ₜ=xₜ−μₜ (25)

Consider a set of mixture Gaussian based HMMs

Λ=(μₛ,Σₛ), 1≦s≦S

where s is a Gaussian component. The following derivations are consistent when s is a cluster of Gaussian components which share the same parameters.

Given the observation sequence O=(o₁, o₂, . . . , o_{T}) for the training set, the maximum likelihood estimation is commonly used to estimate the optimal models by maximising the following likelihood function:

$$\overline{Λ} = {arg max}_{Λ} P ( O ; Λ ) \qquad ( 26 )$$

SAT is based on the maximum likelihood criterion and aims at separating two processes: the phonetically relevant variability and the speaker specific variability. By modelling and normalising the variability of the speakers, SAT can produce a set of compact models which ideally reflect only the phonetically relevant variability.

Consider the training data set collected from R speakers. The observation sequence O can be divided according to the speaker identity

O={O^{r}}={(o₁^{r}, . . . , o_{T}_{^{r}}^{r}}, r=1,2, . . . , R (27)

For each speaker r, a transformation G^{r} is used to generate the speaker dependent model G^{r}(Λ). Supposing the transformations are only applied to the mean vectors, the transformation G^{r}=(A^{r},B^{r}) provides a new estimate of the Gaussian means:

μ^{r}=A^{r}μ+β^{r} (28)

where A^{r} is D×D transformation matrix, D denoting the dimension of acoustic feature vectors and β^{r} is an additive bias vector.

With the set of transformations for R speakers Ψ=(G⁽¹⁾, . . . , G^{(R)}), SAT will jointly estimate a set of generic models Λ and a set of speaker dependent transformations under the maximum likelihood criterion defined by:

$$( \overline{Λ} , \overline{Ψ} ) = {arg max}_{Λ , Ψ} {\prod }_{r = 1}^{R} P ( {O}^{r} ; {G}^{r} ( Λ ) ) \qquad ( 29 )$$

To maximise this objective function, an Expectation-Maximisation (EM) algorithm is used. Since the re-estimation is only effected on the mixture Gaussian components, the auxiliary function is defined as:

$$\begin{matrix}Q ( Ψ ( Λ ) , \overline{Ψ} ( Λ ) ) = C + P ( O \vert Ψ ( Λ ) ) {\sum }_{r , s , t}^{R , S , {T}_{r}} {γ}_{s}^{r} ( t ) log N ( {o}_{t}^{r} , {\overline{μ}}_{s}^{r} , {\overline{Σ}}_{s} ) \\ = C + P ( O \vert Ψ ( Λ ) ) {\sum }_{r , s , t}^{R , S , {T}_{r}} {γ}_{s}^{r} ( t ) log N \\ ( {o}_{t}^{r} , {\overline{A}}^{r} {\overline{μ}}_{s} + {\overline{β}}^{r} , {\overline{Σ}}_{s} )\end{matrix} \qquad ( 30 )$$

where C is a constant dependent on the transition probabilities, R is the number of speakers in the training data set, S is the number of Gaussian components, Tᵣ is the number of units of the speech data from speaker r, and γₛ^{r}(t) is the posterior probability that observation oₜ^{r} from speaker r is drawn according to the Gaussian s.

To estimate the three sets of parameters efficiently, the speaker-specific transformations, the mean vectors and the covariance matrices, a three-stage iterative scheme is used to maximise the above Q-function. At each stage, one set of parameters is updated and the other two sets of parameters are kept fixed [20].

FIG. 6 shows the framework of the TTS module 119 of FIG. 3. The TTS block 119 accepts text 117 and generates synthesised speech 316 as output.

The TTS module consists of three main components: text processing 300, prosody generation 306 and speech generation 312 [21]. The text processing component 300 analyses an input text 117 with reference to dictionaries 302 and generates intermediate linguistic and phonetic information 304 that represents pronunciation and linguistic features of the input text 117. The prosody generation component 306 generates prosody information (duration, pitch, energy) with one or more prosody models 308. The prosody information and phonetic information 304 are combined in a prosodic and phonetic information signal 310 and input to the speech generation component 312. Block 312 generates the final speech utterance 316 based on the pronunciation and prosody information 310 and speech unit database 314.

In recent times, TTS techniques have advanced significantly. With state-of-the-art technology, TTS systems can generate very high quality speech [22, 23, 24]. This makes the use of a TTS system in utterance verification processes possible. A TTS module can enhance an utterance verification process in at least two ways: (1) The prosody model generates prosody parameters of the given text. The parameters can be used to evaluate the correctness and naturalness of prosody of the user's recorded speech; and (2) the speech generated by the TTS module can be used as a speech reference template for evaluating the user's recorded speech.

The prosody generation component of the TTS module 119 generates correct prosody for a given text. A prosody model (block 308 in FIG. 6) is built from real speech data using machine learning approaches. The input of the prosody model is the pronunciation features and linguistics features that are derived from the text analysis part (text processing 300 of FIG. 6) of the TTS module. From the input text 117, the prosody model 308 predicts certain speech parameters (pitch contour, duration, energy, etc), for use in speech generation module 312.

A set of prosody parameters is first determined for the user's language. Then, a prosody model 308 is built to predict the prosody parameters. The prosody speech model can be represented by the following:

cᵢ=λᵢ(F) (31)

pᵢ=μᵢ(cᵢ) (32)

sᵢ=σᵢ(cᵢ) (33)

where F is the feature vector, cᵢ, pᵢ and sᵢ are class ID of the CART (classification and regression tree) tree node, mean value of the class, standard deviation of the class for the i-th prosody parameter respectively.

The predicted prosody parameters are used (1) to find the proper speech units in the speech generation module 312, and (2) to calculate the prosody score for utterance verification.

The speech generation component generates speech utterances based on the pronunciation (phonetic) and prosody parameters. There are a number of ways to generate speech [21, 24]. Among them, one way is to use the concatenation approach. In this approach, the pronunciation is generated by selecting correct speech units, while the prosody is generated either by transforming template speech units or just selecting a proper variant of a unit. The process outputs a speech utterance with correct pronunciation and prosody.

The unit selection process is used to determine the correct sequence of speech units. This selection process is guided by a cost function which evaluates different possible permutations of sequences of the generated speech units and selects the permutation with the lowest “cost”; that is, the “best fit” sequence is selected. Suppose a particular sequence of n units is selected for a target sequence of n units. The total “cost” of the sequence is determined from:

$${C}_{Total} = {\sum }_{i = 1}^{n} {C}_{Unit} ( i ) + {\sum }_{i = 0}^{n} {C}_{Connection} ( i ) \qquad ( 34 )$$

where the C_{Total} is total cost for the selected unit sequence, C_{Unit}(i) is the unit cost of unit i, C_{Connection}(i) is the connection cost between unit i and unit i+1. Unit 0 and n+1 are defined as start and end symbols to indicate the start and end respectively of the utterance. The unit cost and connection cost represent the appropriateness of the prosody and coarticulation effects of the speech units.

FIGS. 7 and 8 are block diagrams illustrating the framework of an overall speech utterance verification apparatus with or without the use of TTS.

For FIG. 7, the steps are explained below:
The TTS component converts the input text into a speech signal and generates reference prosody at the same time.
The prosody derivation block calculates prosody parameters from speech signal.
The acoustic evaluation block compares the two input speech utterances and outputs an acoustic score.
The prosodic evaluation block compares the two input prosody descriptions and outputs a prosodic score.
The score fusion block calculates the final score of the whole evaluation. All the scores of unit sequence are summed up in this step.

For FIG. 8, the steps are explained below:
The Prosody derivation block calculates prosody parameters from speech signal.
The acoustic evaluation block compares the two input speech utterances and outputs an acoustic score.
The prosodic evaluation block compares the two input prosody descriptions and outputs a prosodic score.
The score fusion block calculates the final score of the whole evaluation. All the scores of unit sequence are summed up in this step.

It will be appreciated that the invention has been described by way of example only and that various modifications in design may be made without departure from the spirit and scope of the invention. It will also be appreciated that applications of the invention are not restricted to language leaning, but extends to any system of speech recognition including, for example, voice authentication. Finally, it will be appreciated that features presented with respect to one disclosed apparatus may be presented and/or claimed in combination with another disclosed apparatus.

### REFERENCES

The following documents are incorporated herein by reference.
1. L. R. Rabiner, “A tutorial on hidden Markov models and selected applications in speech recognition,” Proc. IEEE, Vol. 77, No. 2, pp. 257-286, 1989.
2. S. J. Young, “A review of large-vocabulary continuous speech recognition,” IEEE Signal Processing Magazine, vol. 13, pp. 45-57, September 1996.
3. J. L. Gauvain and L. Lamel, “Large-vocabulary continuous speech recognition: advances and applications,” Proc. IEEE, Vol. 88, No. 8, pp. 1181-1200, 2000.
4. R. C. Rose, “Discriminant wordspotting techniques for rejecting non-vocabulary utterances in unconstrained speech,” Proc. ICASSP, 1992.
5. R. A. Sukkar and J. G. Wilpon, “A two pass classification for utterance rejection in keyword spotting,” Proc. ICASSP, 1993.
6. R. A. Sukkar and C.-H. Lee, “Vocabulary independent discriminative utterance verification for nonkeyword rejection in subword based speech recognition,” IEEE Trans. on Speech and Audio Processing, vol. 4, no. 6, November 1996.
7. M. G. Rahim, C.-H. Lee, and B.-H. Juang, “Discriminative utterance verification for connected digits recognition,” IEEE Trans. on Speech and Audio Processing, vol. 5, no. 3, pp. 266-277, 1997.
8. M. G. Rahim, C.-H. Lee, and B.-H. Juang, “Discriminative utterance verification using minimum string verification error (MSVE) training,” Proc. ICASSP, 1996.
9. C. Pao, P. Schmid and J. Glass, “Confidence scoring for speech understanding systems,” Proc. ICSLP, 1998.
10. R. Zhang and A. I. Rudnicky, “Word level confidence annotation using combinations of features,” Proc. Eurospeech, 2001.
11. S. Cox and S. Dasmahapatra, “High-level approaches to confidence estimation in speech recognition,” IEEE Trans. on Speech and Audio Processing, vol. 10, no. 7, pp. 460-471, 2002.
12. H. Jiang, F. Soong and C.-H. Lee, “A dynamic in-search data selection method with its applications to acoustic modeling and utterance verification,” IEEE Trans. on Speech and Audio Processing, vol. 13, no. 5, pp. 945-955, 2005.
13. H. Jiang and C.-H. Lee, “A new approach to utterance verification based on neighborhood information in model space,” IEEE Trans. on Speech and Audio Processing, vol. 11, no. 5, pp. 425-434, 2003.
14. S. F. Boll, “Suppression of acoustic noise in speech using spectral subtraction,” IEEE Trans. Acoustics, Speech and Signal Processing, 27:113-120, April 1979.
15. B. S. Atal, “Effectiveness of linear prediction characteristics of the speech wave for automatic speaker identification and verification,” Journal Acout. Soc. Am., 55(6):1304-1312, 1974.
16. A. Acero and R. M. Stern, “Environmental robustness in automatic speech recognition,” Proc. ICASSP, 1990.
17. M. Rahim and B.-H. Juang, “Signal bias removal by maximum likelihood estimation for robust telephone speech recognition,” IEEE Trans. Speech and Audio Processing, 4(1):19-30, 1996.
18. A. Sankar and C.-H. Lee, “A maximum likelihood approach to stochastic matching for robust speech recognition,” IEEE Trans. Speech and Audio Processing, 4(3):190-202, 1996.
19. L. Lee and R. C. Rose, “Speaker normalization using efficient frequency warping procedures,” Proc. ICASSP, 1996.
20. T. Anastasakos, J. McDonough, R. Schwartz, and J. Makhoul, “A compact model for speaker-adaptive Training,” Proc. ICSLP, 1996.
21. Sproat, R., editor, Multilingual Text-to-Speech Synthesis: The Bell Labs Approach, Kluwer Academic Publishers, 1998.
22. Black, A. and Lenzo, K. Optimal Data Selection for Unit Selection Synthesis. In 4th ESCA Workshop on Speech Synthesis, Scotland, 2001.
23. Chu, Min; Peng, Hu and Chang, Eric. A Concatenative Mandarin TTS System without Prosody Model and Prosody Modification. Proc. of 4th ISCA Tutorial and Research Workshop on Speech Synthesis, Perthshire, Scotland, August 29-Sep. 1, 2001.
24. Dutoit, T. An Introduction to Text to Speech Synthesis. Kluwer Academic Publishers. 1997.
25. Shen, Xiao-Nan. The Prosody of Mandarin Chinese. University of California Press, 1990.
26. Shih, Chilin, and Kochanski, Greg. Chinese Tone Modeling with Stem-ML. In Proceedings of the International Conference on Spoken Language Processing, (Beijing, China), ICSLP, 2000.
27. J. L. Gauvain and L. Lamel, “Large-vocabulary continuous speech recognition: advances and applications,” Proc. IEEE, Vol. 88, No. 8, pp. 1181-1200, 2000.
28. Titterington, D., A. Smith, and U. Makov “Statistical Analysis of Finite Mixture Distributions,” John Wiley & Sons (1985).
29. Breiman, L., Friedman, J. H., Olshen, R. A., and Stone, C. J.: Classification and Regression Trees. Chapman & Hall, New York, (1984).

1. An apparatus for speech utterance verification, the apparatus being configured to compare a first prosody component derived from a recorded speech utterance with a corresponding second prosody component for a reference speech utterance and to determine a prosodic verification evaluation for the recorded speech utterance unit in dependence of the comparison.

2. The apparatus according to claim 1, wherein the apparatus is configured to determine the prosodic verification evaluation from a comparison of first and second prosody components which are corresponding components for at least one of:
speech utterance unit duration;
speech utterance unit pitch contour;
speech utterance rhythm; and
speech utterance intonation; of the recorded and reference speech utterances respectively.

3. The apparatus according to claim 2, the apparatus being configured to determine the prosodic verification evaluation from a comparison of first and second prosody components for speech utterance unit duration from a transform of a normalised duration deviation of the recorded speech utterance unit duration to provide a transformed normalised duration deviation.

4. The apparatus according to claim 2, the apparatus being configured to determine the prosodic verification evaluation from a comparison of first and second groups of prosody components for speech utterance unit pitch contour from:
a transform of a prosody component of the recorded speech utterance unit to provide a transformed prosody component;
a comparison of the transformed prosody component with a corresponding predicted prosody component derived from the reference speech utterance unit to provide a normalised transformed prosody component;
a vectorisation of a plurality of normalised transformed prosody components to form a normalised parameter vector; and
a transform of the normalised parameter vector to provide a transformed normalised parameter vector.

5. The apparatus according to claim 2, the apparatus being configured to determine the prosodic verification evaluation from a comparison of first and second prosody components for speech utterance rhythm from:
a determination of recorded time intervals between pairs of recorded speech utterance units;
a determination of reference time intervals between pairs of reference speech utterance units;
a normalisation of the recorded time intervals with respect to the reference time intervals to provide a normalised time interval deviation for each pair of recorded speech utterance units; and
a transform of a sum of a plurality of normalised time interval deviations to provide a transformed normalised time interval deviation.

6. The Apparatus according to claim 2, the apparatus being configured to determine the prosodic verification evaluation from a comparison of first and second prosody components for speech utterance intonation from:
a determination of the recorded pitch mean of a plurality of recorded speech utterance units;
a determination of the reference pitch mean of a plurality of reference speech utterance units;
a normalisation of the recorded pitch mean and the reference pitch mean to provide a normalised pitch deviation; and
a transform of a sum of a plurality of normalised pitch deviations to provide a transformed normalised pitch deviation.

7. The apparatus according to claim 2, wherein the apparatus is configured to determine a composite prosodic verification evaluation from one or more of:
the transformed normalised duration deviation;
the transformed normalised parameter vector;
the transformed normalised time interval deviation; and
the transformed normalised pitch deviation.

8. The apparatus according to claim 7, wherein the apparatus is configured to determine a composite prosodic verification evaluation from a weighted sum of at least two of:
the transformed normalised duration deviation;
the transformed normalised parameter vector;
the transformed normalised time interval deviation; and
the transformed normalised pitch deviation.

9. The apparatus according to claim 1, the apparatus being configured to:
generate a recorded speech utterance prosody vector for the recorded speech utterance;
generate a reference prosody vector for the reference speech utterance; and
transform the recorded speech utterance prosody vector to generate a transformed recorded speech utterance vector;
wherein the first prosody component comprises the transformed recorded speech utterance prosody vector and the second prosody component comprises the recorded speech utterance prosody vector.

10. The apparatus according to claim 9, the apparatus being configured to normalise a result of the comparison to generate a normalised deviation prosody vector and to convert the normalised deviation prosody vector using a probability function and a score model to determine the prosodic verification evaluation.

11. The apparatus according to claim 9, wherein the apparatus is configured to determine the prosodic verification evaluation for at least one of recorded speech utterance unit prosody and recorded speech utterance across-unit prosody.

12. The apparatus according to claim 11, wherein the apparatus is configured to determine a composite prosodic verification evaluation from a weighted sum of a prosodic verification evaluation for recorded speech utterance unit prosody and a prosodic verification evaluation for recorded speech utterance across-unit prosody.

13. (canceled)

14. The apparatus according to claim 1, wherein the apparatus further comprises a text-to-speech module, the apparatus being configured to generate the reference speech utterance using the text-to-speech module.

15. The apparatus according to claim 14, wherein the apparatus is configured to generate an acoustic model, to determine an acoustic verification evaluation from the acoustic model, and to determine an overall verification evaluation from the acoustic verification evaluation and the prosodic verification evaluation.

16. The apparatus according to claim 15, the apparatus being configured to generate the acoustic model from a speaker adaptive training module.

17. The apparatus according to claim 15, wherein the apparatus is configured to determine the acoustic verification evaluation from:
a normalisation of a first acoustic parameter derived from the recorded speech utterance unit;
a normalisation of a corresponding second acoustic parameter for the reference speech utterance unit;
a determination of a first likelihood value that the first acoustic parameter corresponds to a particular utterance;
a determination of a second likelihood value that the second acoustic parameter corresponds to a particular utterance; and
a comparison of the first likelihood value and the second likelihood value.

18. An apparatus for speech pronunciation verification, the apparatus being configured to determine an acoustic verification evaluation from:
a determination of a first likelihood value that a first acoustic parameter derived from a recorded speech utterance unit corresponds to a particular utterance;
a determination of a second likelihood value that a second acoustic parameter derived from a reference speech utterance unit corresponds to a particular utterance; and
a comparison of the first likelihood value and the second likelihood value;
wherein the first acoustic parameter and the second acoustic parameter are normalised prior to determination of the first and second likelihood values.

19. The apparatus according to claim 18, wherein the determination of the first likelihood value and the second likelihood value is made with reference to a phonetic model.

20-42. (canceled)
